(19) United States
(12) Patent Application Publication
(10) Pub. No.: US 2026/0135800 A1
(43) Pub. Date: May 14, 2026

(54) PARALLEL COMMUNICATION ACROSS A PLURALITY OF TRANSPORT LINKS IN COMMUNICATION NETWORKS

(71) Applicant: VIASAT, INC., Carlsbad, CA (US)

(72) Inventors: Theodore A. Suszczynski, Vista, CA (US); William R. Costanza, Oceanside, CA (US)

(73) Assignee: VIASAT, INC., Carlsbad, CA (US)

(21) Appl. No.: 19/385,051

(22) Filed: Nov. 10, 2025

Related U.S. Application Data
(63) Continuation of application No. PCT/US2023/021588, filed on May 9, 2023.

(51) Int. Cl. H04L 45/24

(52) U.S. Cl. CPC H04L 45/24

(57) ABSTRACT

Technologies are disclosed that provide for parallel communication paths across a plurality of transport links in a communications network, such as a tactical network. Parallel communication can be provided using a performance enhancing proxy layered with parallel tunnels. Multiple network sessions can be established in parallel to enable transmission of connection-oriented network traffic over the parallel tunnels. Various session parameters can be adjusted to address issues associated with transmitting connection-oriented network traffic over parallel transport links with high latency and/or significant differences in latency.

### CROSS-REFERENCE TO RELATED APPLICATION(S)

This application is a continuation of International Patent Application No. PCT/US 2023/021588 filed May 9, 2023, the entire contents of which is incorporated by reference herein for all purposes.

### BACKGROUND

### Field

The present disclosure generally relates to parallel communication across a plurality of transport links in a communication network.

### Description of Related Art

Tactical networks are used to establish communications between various systems such as military systems and other government and national defense systems. These systems typically have access to multiple different types of communication paths using radiofrequency (RF) communications systems. These communication paths can be provided by tactical data links and equipment can be used that provide interoperability among differing transport links. Tactical networks typically offer secure network communications and can be used for the transmission and exchange of tactical data among partners.

### SUMMARY

In some aspects, the techniques described herein relate to a method for multipath aggregation in a communications system that includes a plurality of transport links between an edge router and an aggregation hub, the method including: receiving network traffic at the edge router from a network device; establishing a first network session between the network device and the edge router for connection-oriented network traffic; establishing a second network session for connection-oriented network traffic between the edge router and the aggregation hub; establishing a secure tunnel for each the plurality of transport links; transmitting the network traffic in parallel over the plurality of transport links using the corresponding plurality of secure tunnels; and adjusting one or more parameters associated with the second network session to enable parallel transmission of connection-oriented network traffic over the plurality of transport links.

In some implementations, adjusting the one or more parameters includes disabling a resend time window associated with a corresponding connection-oriented protocol. In some implementations, the method further includes receiving a set of acknowledgements corresponding to transmitted connection-oriented network traffic; identifying missing acknowledgements in the set of acknowledgements; and responsive to identifying a missing acknowledgement, retransmitting network traffic corresponding to the missing acknowledgement. In some implementations, adjusting the one or more parameters includes: storing an expected round-trip time for each of the plurality of transport links; tracking an actual round-trip time for each of the plurality of transport links; and responsive to determining that the actual round-trip time exceeds the expected round-trip time for a particular transport link, adjusting a resend time window in accordance with the actual round-trip time. In some implementations, adjusting the one or more parameters includes transmitting compressed packets corresponding to the received network traffic.

In some implementations, the method further includes receiving the transmitted network traffic at the aggregation hub; reordering packets of the transmitted network traffic to match a packet order of the network traffic prior to being transmitted over the plurality of transport links; transmitting spoofed acknowledgements corresponding to the transmitted network traffic; and directing the transmitted traffic to a destination network device.

In some implementations, the connection-oriented network traffic includes transport control protocol (TCP) traffic. In some implementations, the network traffic includes connectionless network traffic that includes user datagram protocol (UDP) traffic.

In some aspects, the techniques described herein relate to a method further including determining a transport link of the plurality of transport links for each packet of the received network traffic based at least in part on a weighted algorithm including weights associated with a congestion level of the associated transport link. In some implementations, the weighted algorithm is a round-robin weighted algorithm.

In some aspects, the techniques described herein relate to an edge router in a communications system that includes a plurality of transport links between the edge router and an aggregation hub, the edge router including: a performance enhancing proxy (PEP) module configured to establish network sessions for connection-oriented traffic; a multipath virtual private network (MPVPN) module configured to establish secure tunnels over the plurality of transport links and to direct network traffic over the established secure tunnels; a plurality of network interfaces configured to communicate with the plurality of transport links; a data store storing computer executable instructions; and a processor configured to control operation of the data store, the plurality of network interfaces, the PEP module, and the MPVPN module, the processor configured execute the computer executable instructions to: receive network traffic at the edge router from a network device; establish a first network session between the network device and the edge router for connection-oriented network traffic from the network device; establish a second network session with the aggregation hub for connection-oriented network traffic between the edge router and the aggregation hub; establish a secure tunnel for each the plurality of transport links; transmit the network traffic in parallel over the plurality of transport links using the corresponding plurality of secure tunnels; and adjust one or more parameters associated with the second network session to enable parallel transmission of connection-oriented network traffic over the plurality of transport links.

In some implementations, the network traffic includes connectionless network traffic that includes user datagram protocol (UDP) traffic. In some implementations, the connection-oriented network traffic includes transport control protocol (TCP) traffic.

In some implementations, adjusting the one or more parameters includes disabling a resend time window associated with a corresponding connection-oriented protocol. In some implementations, execution of the computer executable instructions further causes the processor to: receive a set of acknowledgements corresponding to transmitted connection-oriented network traffic; identify missing acknowledgements in the set of acknowledgements; and responsive to identifying a missing acknowledgement, retransmit network traffic corresponding to the missing acknowledgement.

In some implementations, adjusting the one or more parameters includes: store an expected round-trip time for each of the plurality of transport links; track an actual round-trip time for each of the plurality of transport links; and responsive to determining that the actual round-trip time exceeds the expected round-trip time for a particular transport link, adjust a resend time window in accordance with the actual round-trip time. In some implementations, adjusting the one or more parameters includes transmitting compressed packets corresponding to the received network traffic.

In some implementations, execution of the computer executable instructions further causes the processor to assign packets of the network traffic to individual transport links to transmit the network traffic in parallel over the plurality of transport links. In some implementations, execution of the computer executable instructions further causes the processor to determine a transport link of the plurality of transport links for each packet of the received network traffic based at least in part on a weighted algorithm including weights associated with a congestion level of the associated transport link. In some implementations, the weighted algorithm is a round-robin weighted algorithm.

In some aspects, the techniques described herein relate to an aggregation hub in a communications system that includes a plurality of transport links between an edge router and the aggregation hub, the aggregation hub including: a performance enhancing proxy (PEP) module configured to establish a first network session between the aggregation hub and a destination network device and a second network session between the aggregation hub and the edge router; a multipath virtual private network (MPVPN) module configured to receive network traffic from the edge router over a plurality of secure tunnels over the plurality of transport links; a plurality of network interfaces configured to communicate with the plurality of transport links; a data store storing computer executable instructions; and a processor configured to control operation of the data store, the plurality of network interfaces, the PEP module, and the MPVPN module, the processor configured execute the computer executable instructions to: receive the network traffic from the edge router in parallel over the plurality of transport links, the network traffic including a plurality of packets; reorder packets of the received network traffic to match a packet order of the network traffic as transmitted from the edge router; transmit to the edge router spoofed acknowledgements for connection-oriented packets of the received network traffic in accordance with the second network session; and direct the received network traffic to the destination network device, the network traffic including connection-oriented network traffic and connectionless network traffic.

In some implementations, the connection-oriented network traffic includes transport control protocol (TCP) traffic. In some implementations, the connectionless network traffic includes user datagram protocol (UDP) traffic.

In some implementations, execution of the computer executable instructions further causes the processor to: detect a missing acknowledgement from the destination device; and retransmit network traffic corresponding to the missing acknowledgement. In some implementations, execution of the computer executable instructions further causes the processor to buffer the received network traffic using the MPVPN module prior to reordering the packets. In some implementations, a size of a buffer is adjusted by the MPVPN module based on a latency difference between the plurality of transport links and a throughput of the plurality of transport links.

For purposes of summarizing the disclosure, certain aspects, advantages and novel features have been described herein. It is to be understood that not necessarily all such advantages may be achieved in accordance with any particular embodiment. Thus, the disclosed embodiments may be carried out in a manner that achieves or optimizes one advantage or group of advantages as taught herein without necessarily achieving other advantages as may be taught or suggested herein.

### BRIEF DESCRIPTION OF THE DRAWINGS

FIG. 1A illustrates an example communications system that is configured to transfer data in parallel over a plurality of transport links between an edge router and an aggregation hub.

FIG. 1B illustrates the transmission of packets over the transport links in the communications system of FIG. 1A to demonstrate packet ordering over transport links.

FIG. 2 illustrates an example multipath aggregation system, similar to the communications system of FIG. 1A.

FIG. 3 illustrates an example of an edge router that can be used in any of the communications systems disclosed herein.

FIG. 4 illustrates an example aggregator that can be used in any of the communications systems described herein.

FIG. 5 illustrates an example router that can be used in any of the communications systems described herein.

FIG. 6 illustrates a flow chart of an example method for multipath aggregation in a communications system.

FIG. 7 illustrates a flow chart of an example method for multipath aggregation in a communications system.

### DETAILED DESCRIPTION OF SOME EMBODIMENTS

The headings provided herein, if any, are for convenience only and do not necessarily affect the scope or meaning of the claimed invention.

### Overview

Tactical networks use tactical data links to establish communications between various systems such as military systems, government systems, and national defense systems. These systems typically have access to multiple different types of communication paths, but no mechanism to allow data flows to be transmitted across multiple paths concurrently or in parallel. This is suboptimal because it does not take advantage of the available network capacity.

Accordingly, disclosed herein are systems, devices, and methods that provide for parallel communication paths across a plurality of transport links in a communications network. An example of such a communications network is a tactical network. Parallel communication can be provided using parallel tunnels. Individual packets can be directed along individual transport links based at least in part on link capacity, link characteristics, congestion control algorithms, weighting algorithms, and the like. For network traffic sent using a transport layer protocol that utilizes a handshake to establish a connection between a client and a destination in a network (a connection-oriented protocol), such as the transport control protocol (TCP), an edge router can establish a network session with an aggregation hub (e.g., using a performance enhancing proxy (PEP)). This session can be configured to reduce the likelihood and/or amount of re-transmission of packets, which may be particularly beneficial when using a variety of transport links with differing latencies with one or more transport links having a high latency. The network traffic (e.g., connection-oriented traffic and connectionless traffic) can be directed along the individual tunnels established on the respective transport links. In some implementations, this can be accomplished on a packet-by-packet basis. In some implementations, this can be accomplished using virtual private network (VPN) technologies over parallel communication paths, referred to herein as a multipath virtual private network (MPVPN).

Thus, the disclosed routers can advantageously employ a PEP layered with MPVPN to provide communication over parallel transport links, which may be particularly advantageous in communications networks with transport links of differing characteristics. For example, the PEP enables the router to use connection-oriented protocols (such as TCP) over the parallel tunnels established by the MPVPN.

The disclosed communications systems may be particularly beneficial in networks that operate in a disconnected, intermittent, and limited (DIL) bandwidth environment which includes a contested space where communication links can be challenged. The disclosed communications systems may be particularly beneficial in networks where the links that constitute the network can periodically change, e.g., links can be lost and new links can become available. The disclosed communications systems may be particularly beneficial in networks that include parallel transport links, which can provide alternative transport links in the event a currently-used transport link becomes unavailable. The disclosed technologies also advantageously bond or aggregate multiple parallel transport links to increase data capacity. The disclosed communications systems may be particularly beneficial in wireless networks (e.g., line-of-sight microwave, satellite, etc.) and/or mobile ad hoc networks.

The disclosed communications systems utilize a plurality of transport links with an edge router implemented on a client-side of the communications system and an aggregation hub implemented on a server-side of the communications system. The edge router and the aggregation hub are each a router in the communications system. Each router (e.g., the edge router and the aggregation hub) includes a performance enhancing proxy (PEP) module and an MPVPN module. Each router uses a combination of the PEP module and the MPVPN module to establish tunnels over the plurality of transport links between the edge router and the aggregation hub to transfer network packets. For example, an edge router can establish a tunnel to an aggregation hub over each transport or wide area network link. These tunnels can be considered underlay tunnels. The edge router and the aggregation hub each provide a centralized point to terminate secure tunnels and to relay user traffic and system status to public networks (e.g., the Internet) or private networks (e.g., classified or non-classified private networks), data stores, and user devices. The PEP modules can be used to establish connection-oriented network sessions such as for TCP sessions. The PEP modules on the routers can establish a session between one another for the transmission of packets and the transmission of packet acknowledgements. This can be done to enable the use of connection-oriented protocols over the parallel transport links even where the transport links include a transport link with high latency. The PEP module on the edge router can also be used to establish a network session with a client device on the client-side of the communications system and the PEP module on the aggregation hub can also be used to establish a network session with a destination device (e.g., a server) on the server-side of the communications system.

Upon receiving network traffic at the edge router, the PEP module can establish a session with a PEP module on the aggregation hub for connection-oriented traffic (e.g., TCP traffic). The network traffic can be forwarded to the MPVPN module for parallel transmission over the plurality of tunnels to the aggregation hub. Return network traffic is transmitted from the aggregation hub to the edge router using the same or similar methods. That is, the network session established by the PEP modules is used to manage connection-oriented traffic and network packets are directed to the MPVPN module where it is transmitted in parallel over the plurality of tunnels to the edge router. Connectionless traffic (e.g., UDP traffic) can be forwarded to the MPVPN module by the PEP module as there is no requirement to handle connection-oriented protocols with such network traffic. The PEP modules are primarily used to manage the network session for connection-oriented network traffic and to implement one or more algorithms to facilitate communication of such traffic over parallel transport links, as described in greater detail herein.

As used herein, multipath aggregation can refer to aggregating multiple communication paths (e.g., across transport links) to function as a unified communication path for network traffic between routers in a communications system. Thus, the disclosed systems provide multipath aggregation by combining a plurality of physical transport links into one logical link to realize increased data capacity, throughput, and/or resiliency to degradation on an individual transport link. A PEP module is configured to proxy a connection for network packets, which may be particularly beneficial for connection-oriented network packets (e.g., TCP traffic). The MPVPN module is configured to route packets over tunnels across the plurality of transport links. As used herein, transport links may also refer to wide area network (WAN) links.

In typical communications systems with a plurality of parallel transport links, a primary communication path with one or more secondary communication paths can be selected but the network traffic only flows over a single communication path at a time. In contrast, the disclosed technologies enable routers to send network data on a packet-by-packet basis in parallel over different communication paths.

Furthermore, protocols may be implemented in typical communications systems to enable more efficient use of parallel transport links. For example, typical communications systems may implement a weighted round-robin method to move packets down separate communication paths. This requires the ability to assign weights to the different communication paths by measuring their performance. This can (a) require that packets be sent over each communication path to perform measurement resulting in less available capacity (e.g., it adds overhead), (b) the weights may need to be adjusted frequently depending on the mobility of the system, and (c) if a link is lost, the weighting may not immediately account for this, resulting in packet loss. These disadvantages are ameliorated or eliminated with PEP and MPVPN as implemented in the disclosed communications systems.

In some implementations, the disclosed technologies can be implemented in software defined network (SDN) routers. The routers are configured to leverage the PEP module and the MPVPN module to enable reliable and transparent communications over any combination of transport links, including but not limited to, WiFi, cellular, satellite, tactical network transport devices (such as MANET radios, UHF, Microwave, Free Space Optics, SATCOM), and the like. In some embodiments, the routers implement these modules with radio or modem awareness, where status information from the radio or modem is used to determine viable transport links and/or to select which transport to use for particular network packets. In some embodiments, the routers use the PEP module to provide connection-oriented services to proxy a connection for connection-oriented protocols. This can be done to facilitate the use of connection-oriented protocols over transport links with disparate characteristics such as latency. The PEP module can be layered with the MPVPN module to transport network traffic over multiple paths simultaneously by leveraging VPN technology and tunnels to transport the data. In some embodiments, the routers are configured to reorder network traffic to ensure compatibility with encryptor devices (e.g., Internet protocol encryptor devices such as IPsec encryptor devices). It should be understood that although reference is made to tactical networks, the disclosed technologies can be used in a variety of communications systems that utilize multiple, parallel transport links between network entities (e.g., routers, hubs, etc.).

### Example Communications Systems

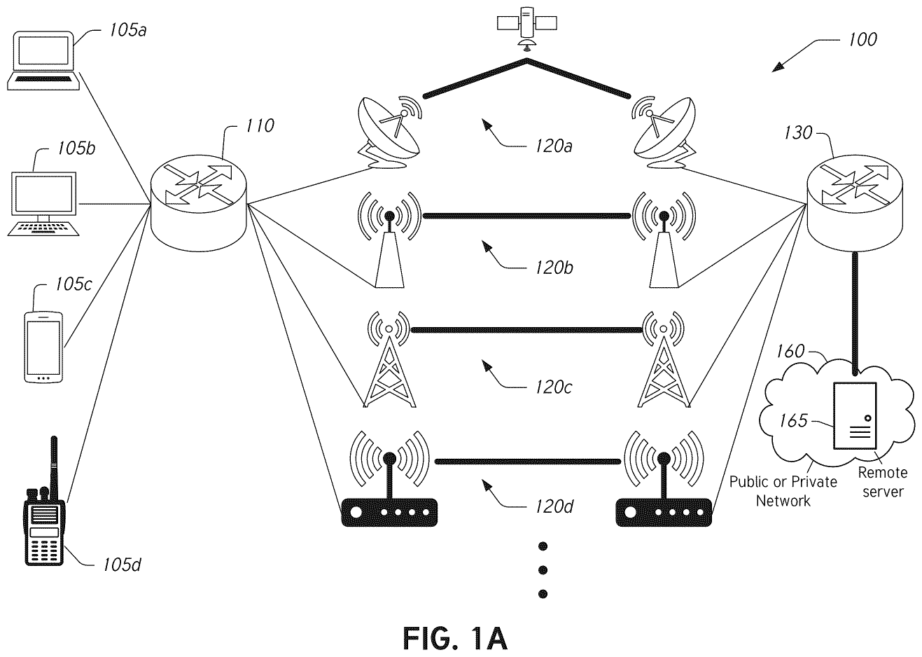

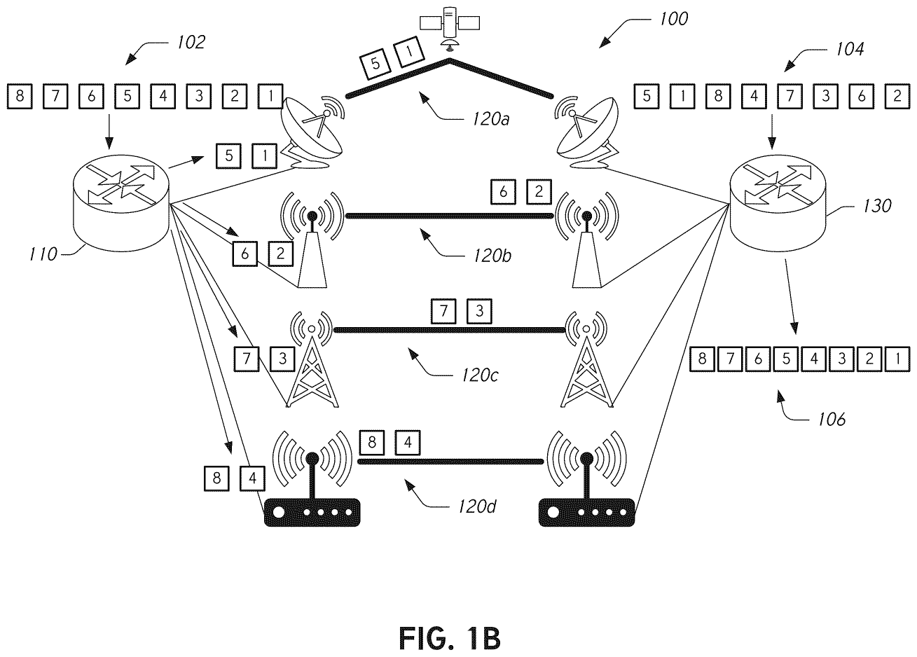

FIG. 1A illustrates an example communications system 100 that is configured to transfer data in parallel over a plurality of transport links 120a-120d between an edge router 110 and an aggregation hub 130. The edge router 110 and the aggregation hub 130 are each configured to use a performance enhancing proxy layered with a multipath VPN to effectively aggregate communication paths, through the transport links 120a-120d. The edge router 110 and the aggregation hub 130 are configured to send data on a packet-by-packet basis over different communication paths using secure tunnels established over each transport link 120a-120d. The edge router 110 and the aggregation hub 130 are configured to enable transmission of connection-oriented network traffic in parallel over the transport links 120a-120d by establishing a connection-oriented network session between the edge router 110 and the aggregation hub 130.

The communications system 100 is configured to direct network traffic between a plurality of user devices 105a-105d and a remote server 165 in a public or private network 160 using the edge router 110, the aggregation hub 130, and the plurality of transport links 120a-120d between the edge router 110 and the aggregation hub 130. The plurality of user devices 105a-105d can be any of a variety of devices configured to communicate with the edge router 110 using wired and/or wireless means. The plurality of user devices 105a-105d can include, for example and without limitation, computers, cellular devices, smartphones, modems, radios, sensors, IoT devices, etc.

The plurality of transport links 120a-120d provide parallel communication paths between the edge router 110 and the aggregation hub 130. The plurality of transport links 120a-120d can be any suitable transport link and can include tactical data links, for example. The plurality of transport links 120a-120d can utilize any suitable communication protocol and equipment and can include, for example and without limitation, cellular communication, WiFi networking, microwave communication, satellite communication, and the like.

The edge router 110 is configured to receive network traffic from the plurality of user devices 105a-105d and to direct the network traffic to the aggregation hub 130 over the plurality of transport links 120a-120d. The edge router 110 aggregates multiple communication paths over the plurality of transport links 120a-120d using a PEP and an MPVPN, as described in greater detail herein. Similarly, the edge router 110 is configured to receive network traffic from the aggregation hub 130 and to direct the network traffic to the destination user device 105a-105d indicated in the network traffic.

In some implementations, the edge router 110 is configured to dynamically route network traffic in parallel over the plurality of transport links 120a-120d, responding to changes in the plurality of transport links 120a-120d (e.g., a transport link falling out of communication, a new transport link being added to the communications system 100, etc.). In some implementations, the edge router 110 (e.g., via the PEP) is configured to manage network traffic via a congestion control algorithm. In some implementations, the edge router 110 (e.g., via the MPVPN) is configured to dynamically route network traffic over the plurality of transport links 120a-120d using a weighted round robin based upon the parameters or characteristics of the plurality of transport links 120a-120d. In certain instances, packet weighting per transport link can be tailored or optimized based at least in part on the characteristics of the transport link.

The aggregation hub 130 is configured to receive network traffic from the edge router 110 over the plurality of transport links 120a-120d. The aggregation hub 130 aggregates multiple communication paths over the plurality of transport links 120a-120d using a PEP and an MPVPN, as described in greater detail herein. The aggregation hub 130 then forwards the network traffic to a target destination indicated by the network traffic, such as a remote server 165 on a public or private network 160 (e.g., the Internet). Similarly, the aggregation hub 130 is configured to receive network traffic from the remote server 165 and to direct the network traffic to the edge router 110 in parallel over the plurality of transport links 120a-120d. In some implementations, similar to the edge router 110, the aggregation hub 130 (e.g., via the PEP) is configured to manage network traffic via a congestion control algorithm. In some implementations, similar to the edge router 110, the aggregation hub 130 (e.g., via the MPVPN) is configured to dynamically route network traffic over the plurality of transport links 120a-120d, responding to changes in the plurality of transport links 120a-120d using a weighted round robin based upon the parameters or characteristics of the plurality of transport links 120a-120d. In certain instances, packet weighting per transport link can be tailored or optimized based at least in part on the characteristics of the transport link.

FIG. 1B illustrates the transmission of packets 102 over the transport links 120a-120d in the communications system 100 to demonstrate packet ordering over a plurality of transport links. The packets are ordered 1 through 8 to illustrate an example of ordered packets 102. First, the packets 102 are sent to the edge router 110 for transmission to the aggregation hub 130. Then, the edge router 110 determines which transport links to use for the transmission of the packets 102. The edge router 110 then directs packets over underlay tunnels between the edge router 110 and the aggregation hub 130 based on these determinations. For example, packets 1 and 5 are directed over the underlay tunnel established on the transport link 120a, packets 2 and 6 are directed over the underlay tunnel established on the transport link 120b, packets 3 and 7 are directed over the underlay tunnel established on the transport link 120c, and packets 4 and 8 are directed over the underlay tunnel established on the transport link 120d. Due at least in part to the varying characteristics of the transport links 120a-120d (e.g., latency, jitter, throughput, etc.), the packets may arrive in a different order than originally transmitted, resulting in the disordered packets 104. Thus, to accommodate transport links with varying characteristics, the aggregation hub 130 is configured to reorder the packets at the underlay tunnel endpoints on the aggregation hub 130 prior to being forwarded, resulting in the reordered packets 106. A similar process is performed for network traffic travelling from the aggregation hub 130 back to the edge router 110. That is, the edge router 110 is also configured to reorder received packets at the underlay tunnel endpoints prior to forwarding the packets.

As described herein, some embodiments of the edge router 110 and/or the aggregation hub 130 include a decision engine that determines which transport links, and therefore which underlay tunnels, to use for transmission of network traffic. The decision engine can be configured to analyze buffer sizes and/or to analyze transport link parameters (e.g., throughput, latency, etc.) in determining which transport link to use to transmit individual data packets. In some embodiments, the decision engine can query the equipment of the transport links 120a-120d, such as the radios of the transport links, to determine the status of the equipment. The status of the equipment can include, for example and without limitation, throughput, latency, jitter, and the like. The status of the equipment can be used to drive metrics for weighting individual transport links in the decision algorithms employed by the decision engine. For example, a round-robin weighted algorithm can be used to determine which transport link to use. This may be particularly beneficial for connectionless network traffic (e.g., UDP traffic).

As described in greater detail herein, the edge router 110 is configured to provide bi-directional, secure connectivity between edge devices, such as the user devices 105a-105d, and the aggregation hub 130 using multiple and disparate wide area network (WAN) links simultaneously, such as the transport links 120a-120d. Furthermore, the aggregation hub 130 is configured to provide a centralized point to terminate secure tunnels to the edge router 110 (and other edge routers) and to relay user network traffic and system status to public networks (e.g., Internet), private networks (e.g., classified or non-classified private networks), data stores, and other target devices and systems. The communications system 100 utilizes a PEP layered with an MPVPN to transmit network traffic over tunnels established between the edge router 110 and the aggregation hub 130. The edge router 110 is configured to establish a tunnel to the aggregation hub 130 over each transport link 120a-120d. Each of these tunnels can be considered an underlay tunnel. The disclosed technologies can be implemented in virtualized and/or hardware router devices. The disclosed technologies can also be implemented in hybrid networking environments. Hybrid networking environments can include, for example, multiple parallel communication paths at least two of which have different transport characteristics from each other.

### Examples of Multipath Aggregation Systems

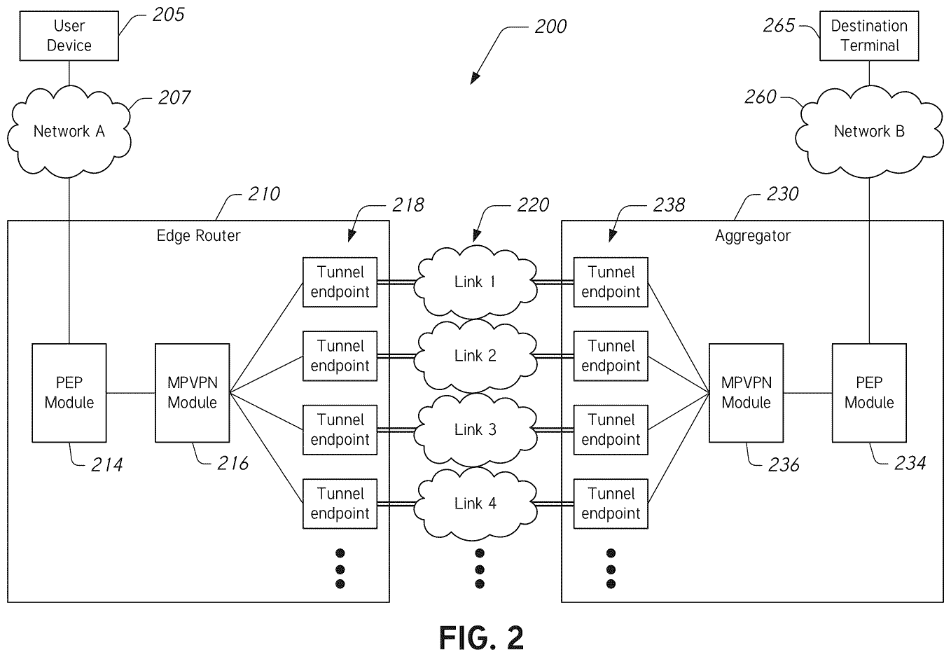

FIG. 2 illustrates an example multipath aggregation system 200, similar to the communications system 100 described herein with reference to FIG. 1A. For example, the multipath aggregation system includes an edge router 210 similar to the edge router 110 of FIG. 1A, an aggregator 230 similar to the aggregation hub 130 of FIG. 1A, and a plurality of transport links 220 similar to the transport links 120a-120d of FIG. 1A. Furthermore, similar to the communications system 100, the multipath aggregation system 200 is configured to connect a user device 205 (of network A 207) to a destination terminal 265 (of network B 260) using the edge router 210 and the aggregator 230 by aggregating the physical transport links 220 into a single logical link between the edge router 210 and the aggregator 230. The user device 205 is similar to the user devices 105a-105d of FIG. 1A and may be part of a private or public network, such as the network A 207. Similarly, the destination terminal is similar to the remote server 165 of FIG. 1A and may be part of a private or public network, such as the network B 260.

The edge router 210 includes a PEP module 214, an MPVPN module 216, and a plurality of tunnel endpoints 218 corresponding to the plurality of transport links 220 (e.g., there is a tunnel endpoint for each transport link). Similarly, the aggregator 230 includes a plurality of tunnel endpoints 238 corresponding to the plurality of transport links 220 (e.g., there is a tunnel endpoint for each transport link), an MPVPN module 236, and a PEP module 234.

In each of the edge router 210 and the aggregator 230, the PEP module 214, 234 is layered with the MPVPN module 216, 236 to address cases in which there is high latency and/or mixed latency in the transport links 220. For example, multipath VPN is suitable for transmitting network data in parallel over the transport links 220 but problems arise where there is a transport link that has a high latency and/or where the transport links 220 differ significantly in latency. In such instances, connection-oriented protocols, such as TCP, may fail or result in multiple retransmissions of data. Consequently, the PEP modules 214, 234 can be configured to establish a connection-oriented network session (e.g., a TCP session) between the PEP modules 214, 234 to proxy connections for connection-oriented protocols. In addition, the PEP modules 214, 234 can be configured to adjust a congestion control algorithm to achieve targeted performance for connection-oriented protocols over the transport links 220. The proxy connections established by the PEP modules 214, 234 along with the adjustments to the congestion control algorithm enable the efficient and effective parallel transmission of connection-oriented protocols over the transport links 220. As a result, the edge router 210 and the aggregator 230 are configured to transmit connection-oriented protocols and connectionless protocols in parallel over the transport links 220 where one or more transport links may have high latency and/or where the latencies of the transport links 220 differ significantly.

A challenge with connection-oriented protocols, such as TCP, over high-latency transport links is that a delay in packet reception requires larger TCP windows at tunnel endpoints. In turn, this requires careful tuning of the TCP windows to reduce or minimize TCP retransmission. This may result in further delay and loss of throughput. Further challenges arise where it is desirable to transport TCP packets in parallel over transport links. Typically, TCP spoofing may be employed over a high latency transport link, but where there are multiple transport links and TCP packets are transmitted in parallel over these transport links, the packets may arrive out of order which causes problems in systems that employ typical TCP spoofing techniques.

Accordingly, the PEP modules 214, 234 are configured to establish a connection-oriented network session (e.g., a TCP session) between the PEP module 214 and the PEP module 234. The established connection-oriented network session can be used to spoof the flow of connection-oriented network traffic between the PEP modules 214, 234 thereby enabling the edge router 210 and the aggregator 230 to handle high latency transport links and/or transport links with latencies that differ significantly. In addition, the PEP module 214 of the edge router 210 is configured to establish a connection-oriented network session with the user device 205 and the PEP module 234 of the aggregator 230 is configured to establish a connection-oriented network session with the destination terminal 265. Thus, the multipath aggregation system 200 can be configured to establish three connection-oriented network sessions: a first session between the user device 205 and the PEP module 214 of the edge router 210, a second session between the PEP module 214 of the edge router 210 and the PEP module 234 of the aggregator 230, and a third session between the PEP module 234 of the aggregator 230 and the destination terminal 265.

For example, in the first session between the user device 205 and the PEP module 214 of the edge router 210, the PEP module 214 can receive data from the user device 205 directed to the destination terminal 265 and can send corresponding acknowledgements to the user device 205 to mimic or spoof the acknowledgements that would be sent by the destination terminal 265. This enables the user device 205 to speed up the TCP slow start and allows the user device 205 to quickly open up its TCP transmit window regardless of the latency between the destination terminal 265 and the user device 205. The PEP module 214 can store the data in a buffer in the event that an actual acknowledgement is not received from the destination terminal 265.

In the second session between the PEP module 214 of the edge router 210 and the PEP module 234 of the aggregator 230, the PEP module 214 can forward the data received from the user device 205 to the PEP module 234. In response, the PEP module 234 can transmit a corresponding acknowledgement to the PEP module 214. If no acknowledgement is received, the PEP module 214 can retransmit the data to the PEP module 234 from its buffer.

In the third session between the PEP module 234 of the aggregator 230 and the destination terminal 265, the PEP module 234 can receive the data from the PEP module 214 and can forward the data to the destination terminal 265. The PEP module 234 can receive a corresponding acknowledgement and suppress the acknowledgement. If no acknowledgement is received, the PEP module 234 can retransmit the data to the destination terminal 265. For network traffic travelling from the destination terminal 265 to the user device 205, the same techniques used in the communication from the user device 205 to the destination terminal 265 can be employed in reverse.

In each session, acknowledgements are expected to be received within a time window. If no acknowledgement is received within the time window, the corresponding data is retransmitted. For the second session, that is the session established between the PEP module 214 of the edge router 210 and the PEP module 234 of the aggregator 230, network traffic can be transmitted in parallel over a plurality of transport links 220. It may occur that one or more of the transport links 220 has a round-trip time that exceeds the time window for receiving acknowledgements. For example, the round-trip time between the edge router 210 and the aggregator 230 over a particular transport link may be relatively large (e.g., for a satellite transport link) and the acknowledgements may not be received within the time window. Similarly, it may occur that there are relatively large differences between latencies of the transport links 220. In these cases, the time window may be too narrow for receiving acknowledgements from high latency transport links. In such instances, the connection-oriented protocol may throttle back its speed. For example, the connection-oriented protocol may interpret large latency values or long times between acknowledgements as evidence of a congested network or packet loss and will not increase the rate at which it sends packets, even though there is no actual congestion or packet loss across the corresponding transport link.

Accordingly, the PEP modules 214, 234 are configured to address the issues resulting from high latency transport links and/or transport links with significantly different latencies. As a first example, the PEP modules 214, 234 are configured to disable the time window for acknowledgements. In this example, the PEP modules 214, 234 wait to receive a set of acknowledgements in response to transmitted data packets. The PEP modules 214, 234 then identify missing acknowledgements in the set and retransmits only the data packets corresponding to the missed acknowledgements.

As a second example, the PEP modules 214, 234 are configured to store expected or nominal values for the round-trip times of the transport links 220 based on characteristics (e.g., latencies) of each transport link 220. If the actual round-trip times for received acknowledgements is greater than the expected round-trip time, the PEP modules 214, 234 are configured to assume congestion. In response, the PEP modules 214, 234 are configured to adjust the time window to reflect the actual round-trip time of the transport links.

As a third example, the PEP modules 214, 234 are configured to transmit compressed packets to improve data throughput across the transport links 220. Various data compression techniques can be employed to improve throughput to increase performance across the transport links 220. Compressing packets may be beneficial because it reduces the number of bytes transmitted over the transport links 220. Compression techniques include link layer compression, TCP and IP header compression, application-specific compression, and the like. An application-specific (or content-specific) compression mechanism can include binary encoding of HTTP headers or a lossy compression that reduces the image quality of inline-images on Web pages according to end user instructions.

The techniques employed by the PEP modules 214, 234 for connection-oriented protocols may not be used for connectionless protocols (e.g., UDP traffic). Such protocols may be passed through the PEP modules 214, 234 to the MPVPN modules 216, 236 for routing over the transport links 220 via the tunnel endpoints 218, 238.

When the user device 205 sends data to the destination terminal 265, the edge router 210 receives the packets through the network A 207. The edge router 210 is configured to receive the packets and to transmit the packets to the aggregator 230 using the PEP module 214 to improve or enhance parallel transmission of connection-oriented protocols over the transport links 220 in conjunction with the MPVPN module 216 to direct network traffic over secure tunnels established on each transport link 220. As used herein, a connection-oriented protocol can include a transport layer protocol with a multi-phase process to establish a connection between endpoints in a network, which may require a handshake protocol between the endpoints. As used herein, a connectionless protocol can include a transport layer protocol with a single-phase process that includes transferring data, without requiring the establishment of a connection between the endpoints or without requiring a handshake protocol between the endpoints. Examples of transport layer protocols include TCP, UDP, QUIC, ESP, and SCTP.

The packets queued at the MPVPN module 216 can be directed in parallel across individual tunnels established on the plurality of transport links 220. The MPVPN module 216 assigns packets to individual transport links 220. The MPVPN module 216 can be configured to account for conditions of individual transport links 220 (e.g., throughput and latency) in assigning packets to individual transport links 220. For example, the MPVPN module 216 may use round-robin techniques weighted in accordance with current network conditions to assign network packets to individual transport links 220. For example, the weights in the round-robin weighted algorithm are associated with a congestion level of the associated transport link.

The MPVPN module 216 can be configured to determine the network capacity of each transport link 220 and to do a weighted round-robin for each transport link 220. In some embodiments, the MPVPN module 216 obtains transport link status (e.g., data rates, throughput, congestion, etc.) by querying the hardware or equipment of the corresponding transport link. For transport links with higher throughput, for example, the MPVPN module 216 can direct more data down such transport links. By querying the radios or equipment directly, the edge router 210 can accommodate transport links 220 that have non-static characteristics. This may be advantageous relative to communications systems that assume transport links have static characteristics. In some embodiments, the MPVPN module 216 can be configured to run a speed test analysis over individual transport links 220 to determine properties of the transport links 220. This can be an alternative to querying the network equipment or in addition to querying the network equipment. The MPVPN module 216 can be configured to update the weighting of transport links 220 based on the characteristics determined using the techniques described herein.

The MPVPN module 216 can be configured to divide up the network traffic based on criteria such as latency, throughput, high availability (e.g., surety of arrival of data, low drop rates, etc.), and the like. The MPVPN module 216 is configured to implement the VPN protocol. Further, the MPVPN module 216 is configured to reorder packets to a correct order (e.g., the order in which they were sent) prior to processing by the VPN protocol where the VPN may be implemented, for example, on the user device 205 or internal to the edge router 210. This is advantageous because VPN protocols typically have replay windows (e.g., IPsec) and check for out-of-order packets. If there are packets that are out of order, the VPN protocol may treat the data as an attack, such as a replay attack. However, this may be undesirable behavior where parallel transport links are employed because packets may arrive out of order due to different latencies on different transport links. Thus, by correcting the order of the packets prior to processing by the VPN protocol, VPN protocols may continue to operate with their typical capabilities.

After processing by the PEP module 214 and the MPVPN module 216, network packets are directed to the tunnel endpoints 218 on the edge router 210. The tunnel endpoints 218 are communicatively coupled to the MPVPN module 216. The edge router 210 can include one secure tunnel endpoint 218 for each transport link 220. Thus, the MPVPN module 216 directs packets in parallel along underlay tunnels between the edge router 210 and the aggregator 230.

The aggregator 230 includes a plurality of tunnel endpoints 238 for each secure tunnel associated with a transport link 220, the tunnel endpoints 238 being communicatively coupled to the MPVPN module 236. For each received packet, the MPVPN module 236 is configured to buffer and reorder the packets to achieve the same packet order as received from the user device 205 over the network A 207. For example, after receiving the transmitted network traffic, the MPVPN module 236 is configured to reorder the packets of the transmitted network traffic to match a packet order of the network traffic prior to being transmitted over the transport links 220. In some embodiments, the MPVPN module 236 is configured to control the size of the buffer based at least in part on the latency difference between the transport links 220, the throughput of the transport links 220, or other such characteristics of the transport links 220. For example, the throughput determines the rate of transmission and the latency difference determines how skewed the packets can be from each other, the buffer is therefore sized to accommodate a number of packets to account for the latency difference based on the throughput. By way of example, if the throughput is 100 packets per second and the latency difference (or delay skew) is 750 ms, the buffer can be sized to accommodate a minimum of 75 packets (750 ms×100 packets/second). The aggregator 230 then directs the network traffic to the destination terminal 265.

For traffic from the destination terminal 265 to the user device 205, the aggregator 230 provides the network functionality described herein with reference to the edge router 210 and the edge router 210 provides the network functionality described herein with reference to the aggregator 230.

Because TCP is a host-to-host connection-based protocol (or a connection-oriented protocol), an established connection is required before transmitting data. TCP also requires creating, maintaining, and closing a connection as part of the protocol. For transferring data, when a source device transmits a packet, TCP requires the destination device to confirm receipt before any additional packets are sent. This can slow down network communication when using a high-latency transport link. To establish a connection, a client initiates a 3-step handshake: the client sends a SYN to the destination device; the destination device sends a SYN-ACK in response; and the client sends an ACK back to the destination device. Similarly, to terminate the connection, the client performs a 4-step handshake: the client sends a FIN packet; the destination device sends an ACK packet; the destination device sends a FIN packet; and the client sends an ACK packet. On the other hand, UDP is a communications-based protocol (or connectionless protocol) and operates process-to-process. UDP does not rely on connection agreements and does not require packet acknowledgment. UDP sends data packets before the destination device agrees and can continue to send packets one after another without confirmed delivery.

The PEP module 214 can act as a performance enhancing proxy (PEP), which may also be referred to as TCP spoofing, and can be configured to intercede in the 3-way handshake of TCP between the user device 205 and the destination terminal 265. For example, the PEP module 214 can receive the SYN from the user device 205 and can respond to the user device 205 with the SYN/ACK packet. The user device 205 can then respond with the ACK packet and the first data packet, such as an HTTP request packet. The PEP module 214 can combine the original SYN packet and the first data packet and can send this to the PEP module 234 of the aggregator 230, thereby reducing the time taken to send the initial request from the user device 205 to the destination terminal 265. In some embodiments, the PEP module 214 acts as a SOCKS proxy for TCP traffic between the user device 205 and the destination terminal 265. This can be extended to other connection-oriented protocols as well.

### Examples of Edge Routers and Aggregators

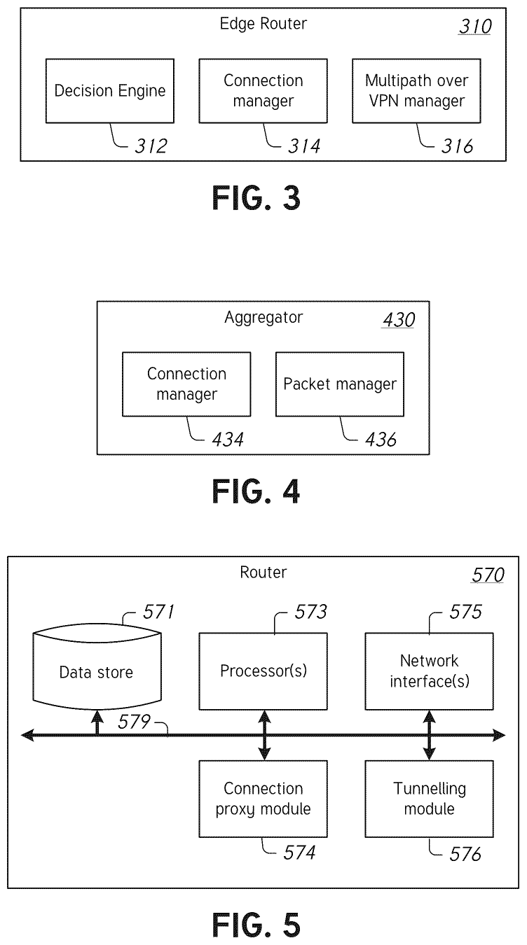

FIG. 3 illustrates an example of an edge router 310 that can be used in any of the communications systems disclosed herein. As used herein, an edge router can be a router located at a network boundary that enables an internal network to connect to external networks. The edge router 310 can be the edge router 110 in the communications system 100 and/or the edge router 210 in the multipath aggregation system 200. The edge router 310 includes a decision engine 312, a connection manager 314, and a multipath over VPN manager 316. The edge router 310 is configured to manage network sessions for connection-oriented protocols using the connection manager 314 and to direct network traffic using the multipath over VPN manager 316. The decision engine 312 is configured to aid the connection manager 314 and the multipath over VPN manager 316 in directing network traffic over a plurality of transport data links communicatively coupled to the edge router 310.

The multipath over VPN manager 316 is configured to manage parallel transmission of network packets for connection-oriented and connectionless protocols while the connection manager 314 is configured to manage network sessions for connection-oriented protocols. The connection manager 314 establishes a network session with a network device, such as a client device, and with another network session with a connection manager on another router, such as an aggregator. The connection manager 314 thus manages sessions for connection-oriented protocols which allows the multipath over VPN manager 316 to transmit network traffic on a packet-by-packet basis over multipath tunnels comprising the plurality of transport links.

The decision engine 312 can be configured to determine which transport link to use for individual data packets of the network traffic. The decision engine 312 can be configured to analyze buffer sizes and to use link parameters (e.g., throughput, latency, etc.) to determine which transport link to use. In some embodiments, the edge router 310 (e.g., using the decision engine 312) can be configured to query radios in a communications system to determine the status of the radios. Based on the status, the decision engine 312 can determine which transport link to use. The status of the radios (or other network communication equipment such as satellite modems and other tactical devices) can include the throughput, latency, and the like. In some implementations, the status of the radios can be used in determining transport links to use based on a weighting algorithm. In some embodiments, querying the radio includes determining the perception of the network from the point of view of the radio. Weighting of the transport links can be adjusted based on the responses from the radios. In some implementations, network traffic may be designated as latency sensitive and the decision engine 312 can assign weights (e.g., lower or higher) to low latency transport links. Similarly, in some implementations, network traffic may be designated as throughput sensitive and the decision engine 312 can assign weights (e.g., lower or higher) to high throughput transport links.

Similarly, the edge router 310 (e.g., using the decision engine 312) can be configured to run a speed test analysis over each transport link to determine characteristics of the transport link. This can be done in addition to or as an alternative to querying the network equipment itself. Weighting of the transport links can be adjusted based on the results of the speed test analysis. Being able to determine changing network characteristics, e.g., by querying network equipment for their status and/or by running a speed test analysis over each transport link, may be advantageous over systems that assume the characteristics of transport links are static because it allows the edge router 310 to automatically react to changing network conditions.

The decision engine 312 can be configured to implement any of a variety of congestion control algorithms. For example, a congestion control algorithm can be implemented that is suitable for a satellite link or a TCP congestion control algorithm can be implemented that is suitable for a terrestrial link. Thus, the decision engine 312 can be configured to determine a congestion control algorithm that is suitable for the connection manager 314 based at least in part on the combination of the underlying transport links.

The edge router 310 is configured to provide robust and resilient connectivity through the use of multiple, simultaneous communication paths. The edge router 310 is configured to bond disparate transport links and networks to enable robust and resilient connectivity across mobile networks, even in contested and congested environments. As described herein, the edge router 310 can be configured to be radio aware (e.g., by querying radios in the network) and to aggregate multiple transport links into a single logical link which allows the edge router 310 to adapt to changes in transport link status and to route or bond packets over available transport links, thereby bringing increased resilience and capacity. It should be noted that a configuration similar to that of the edge router 310 can also be used for the aggregation hub or aggregator, such as the aggregation hub 130 of FIG. 1A or the aggregator 230 of FIG. 2.

FIG. 4 illustrates an example aggregator 430 that can be used in any of the communications systems described herein. As used herein, an aggregator can be an aggregation platform that acts as a central connection point for distributed wide area network traffic that can then be sent to external networks, such as the Internet. The aggregator 430 can be the aggregation hub 130 in the communications system 100 and/or the aggregator 230 in the multipath aggregation system 200. The aggregator 430 includes a connection manager 434 and a packet manager 436. The aggregator 430 is configured to manage network sessions for connection-oriented network traffic using the connection manager 434 and to manage data packets using the packet manager 436. It should be noted that a configuration similar to that of the aggregator 430 can also be used for the edge router, such as the edge router 110 of FIG. 1A or the edge router 210 of FIG. 2.

The aggregator 430 can be configured to manage one or more network sessions using the connection manager 434. The connection manager 434 can be configured to maintain a network session with a connection manager of another router, such as an edge router, and another network session with a destination device, such as a server. Similarly, the connection manager 434 can be configured to send acknowledgements when data is received from an edge router while simultaneously forwarding the received data to the destination device, as described herein.

The aggregator 430 can be configured to manage the transmission of network packets over secure tunnels using the packet manager 436. The aggregator 430 can leverage VPN technology to transmit and receive network packets over secure tunnels. The packet manager 436 can use this technology to transmit network packets in parallel over a plurality of transport links, as described herein. Similarly, the packet manager 436 can be configured to receive network packets from an edge router, for example, and to reorder the network packets to place them in a correct order prior to processing by any VPN or other such technologies. Once reordered, the packet manager 436 can be configured to forward the packets to a destination device.

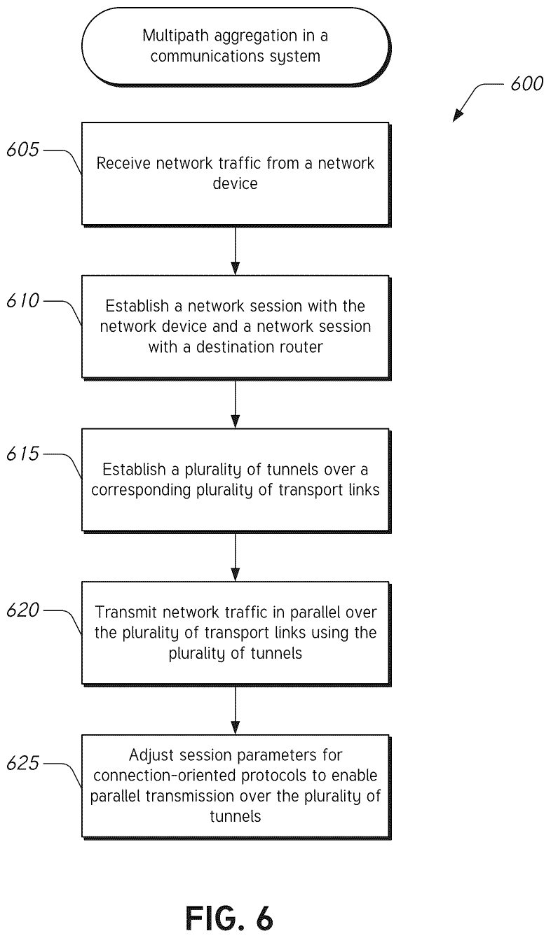

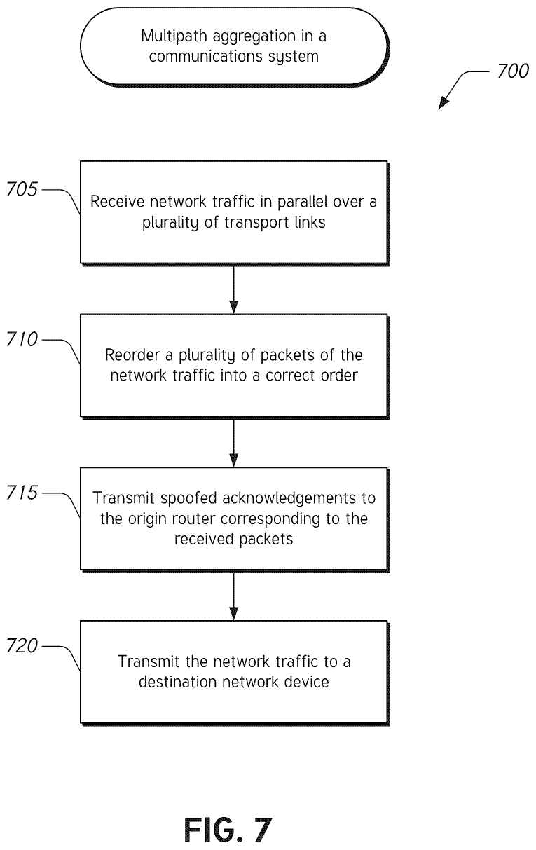

FIG. 5 illustrates an example router 570 that can be used in any of the communications systems described herein. For example, the router 570 can be the edge router 110 and/or the aggregation hub 130 of the communications system 100 or the router 570 can be the edge router 210 and/or the aggregator 230 of the multipath aggregation system 200. The router 570 can employ any method described herein associated with multipath aggregation, such as the example methods 600 and 700 described herein with reference to FIGS. 6 and 7, respectively.

The router 570 can include hardware, software, and/or firmware components for multipath aggregation and transmitting network traffic in parallel across a plurality of transport links. The router 570 includes a data store 571, one or more processors 573, one or more network interfaces 575, a connection proxy module 574, and a tunnelling module 576. Components of router 570 can communicate with one another, with external systems, and with other components of a network using communication bus 579. The router 570 can be implemented in a component of a network communications system. The router 570 can be implemented using one or more computing devices. For example, the router 570 can be implemented using a single computing device, multiple computing devices, a distributed computing environment, or it can be located in a virtual device residing in a public or private computing cloud. In a distributed computing environment, one or more computing devices can be configured to provide the modules 574, 576 to provide the described functionality.

The router 570 includes a connection proxy module 574 and a tunnelling module 576. The connection proxy module 574 is configured to manage network sessions for connection-oriented protocols. For example, the connection proxy module 574 can perform TCP spoofing to enhance performance over transport links with high latency and/or latencies that differ significantly. Network traffic is queued for processing at the tunnelling module 576. The connection proxy module 574 can be configured to implement PEP technology to manage multiple network sessions between devices (e.g., a client device, a server, a destination terminal, etc.) and routers (e.g., an edge router, aggregation hub, aggregator, etc.). The tunnelling module 576 can be configured to implement VPN technology to securely transmit network traffic over tunnels established on the plurality of transport links. This enables the router 570 to aggregate parallel transport links into a single logical link between routers in a communications system.

Similarly, the router 570 is configured to receive network traffic from another router in the communications system and to direct the received network traffic to a user device or destination terminal. Network traffic received from another router can be processed by the tunnelling module 576 to manage incoming packets. The tunnelling module 576 is configured to reorder network packets. The reassembled and reordered network traffic can be forwarded to the user device or destination terminal. The connection proxy module 574 is configured to receive network packets and transmit a spoofed acknowledgement back to the sending router while forwarding the received network packets to the user device or destination terminal.

The router 570 can implement any functionality or algorithm described herein as being performed by a decision engine. Similarly, the connection proxy module 574 can implement any functionality of algorithm described herein as being performed by PEP module or a performance enhancing proxy. Likewise, the tunnelling module 576 can implement any functionality of algorithm described herein as being performed by an MPVPN module or a tunneling multipath VPN.

The router 570 includes one or more processors 573 that are configured to control operation of the modules 574, 576 and the data store 571. The one or more processors 573 implement and utilize the software modules, hardware components, and/or firmware elements configured for multipath aggregation. The one or more processors 573 can include any suitable computer processors, application-specific integrated circuits (ASICs), field programmable gate array (FPGAs), or other suitable microprocessors. The one or more processors 573 can include other computing components configured to interface with the modules 574, 576 and data store 571 of the router 570.

The router 570 includes the data store 571 configured to store configuration data, user requirements, network statuses, network characteristics and capabilities, control commands, databases, algorithms, executable instructions (e.g., instructions for the one or more processors 573), and the like. The data store 571 can be any suitable data storage device or combination of devices that include, for example and without limitation, random access memory, read-only memory, solid-state disks, hard drives, flash drives, and the like.

### Example Methods of Multipath Aggregation

FIG. 6 illustrates a flow chart of an example method 600 for multipath aggregation in a communications system. The method 600 can be performed by a communications system or any component of a communications system (e.g., edge routers, aggregation hubs, or aggregators) disclosed herein. Furthermore, any step or portion of a step of the method 600 can be performed by any suitable component of the communications system disclosed herein. Similarly, any combination of components of the communications system disclosed herein can perform any step or portion of a step of the method 600. However, for ease of description, the method 600 is described as being performed by a router, such as any of the routers disclosed herein including the edge router 110, the aggregation hub 130, the edge router 210, the aggregator 230, the edge router 310, the aggregator 430, and the router 570 described herein with reference to FIGS. 1A-5.

In block 605, the router receives network traffic from a network device. The network device can be a user device, a remote server, a destination terminal, or the like. The network device can be associated with a private or public network to which the router is communicatively coupled. The network traffic can be intended for a destination network device on a second network, the router communicatively coupled to the second network through a second router and a plurality of transport links that communicatively couple the router with the second router. In some embodiments, individual transport links of the plurality of transport links have different network latencies. In some embodiments, at least one transport link is a high-latency transport link.

In block 610, the router establishes a first network session with the network device and a second session with a destination router in the communications system. Where the router is an edge router, the destination router can be an aggregator or aggregation hub, as described herein. Where the router is an aggregator, the destination router can be an edge router, as described herein.

In accordance with the first network session, the router is configured to send ACKs to the network device responsive to receiving a data stream from the network device. In parallel and in accordance with the second network session, the router forwards the data stream to the destination router and waits for corresponding ACKs from the destination router. If corresponding ACKs are received, the router drops them as the router has already transmitted corresponding ACKs to the network device. If no corresponding ACKs are received, the router retransmits the data that did not receive an ACK from the destination router.

In block 615, the router establishes a plurality of tunnels over a corresponding plurality of transport links between the router and the destination router. In some embodiments, the module configured to implement multipath VPN is configured to assign packets to individual transport links on a packet-by-packet basis. To do so, the module configured to implement multipath VPN can account for current conditions of individual transport links, such as throughput and latency. The module configured to implement multipath VPN may use a round-robin technique weighted in accordance with current network conditions to determine which transport link to use for a particular packet.

In block 620, the router transmits the network traffic in parallel over the plurality of transport links using the plurality of tunnels. Thus, the router is configured to aggregate the plurality of transport links into a single logical link for the connectionless network traffic.

In accordance with the second session, the router is configured to forward data packets received from the network device to the destination router. The router is configured to wait for corresponding ACKs from the destination router. Responsive to not receiving a corresponding ACK, the router is configured to retransmit the data packet to the destination router from its buffer. The router is configured to drop received ACKs due at least in part to having already sent spoofed ACKs to the network device.

In block 625, the router adjusts session parameters for connection-oriented protocols to enable parallel transmission of connection-oriented network traffic over the plurality of tunnels. For example, issues may arise with TCP spoofing over a network segment with parallel transport links. To address these issues, the router can be configured to adjust certain parameters of the network session between the router and the destination router.

As a first example, the router can be configured to disable the resend time window. The resend time window corresponds to the amount of time the router is configured to wait for an ACK from the destination device before retransmitting the data. To avoid unnecessary retransmission of data, the router can disable the resend time window. Instead, the router is configured to receive a set of ACKs from the destination router and to identify any missing ACKs in the received set of ACKs. Responsive to identifying one or more missed ACKs, the router retransmits only the data corresponding to the identified missing ACKs.

As a second example, the router can be configured to store an expected or nominal round trip time for each transport link of the plurality of transport links. The router then tracks the actual round-trip times for each transport link. If the actual round-trip time for a particular transport link is greater than the expected round trip time, the router assumes congestion on the corresponding transport link. Responsive to assuming congestion on the transport link, the router adjusts the resend time window in accordance with the actual or measured round-trip time.

As a third example, the router can be configured to adjust the size of the data packets using compression schemes. That is, the router is configured to transmit compressed packets over the plurality of transport links to increase throughput to the destination router. The router can be configured to compress the headers and/or the payload data.

FIG. 7 illustrates a flow chart of an example method 700 for multipath aggregation in a communications system. The method 700 can be performed by a communications system or any component of a communications system (e.g., edge routers, aggregation hubs, or aggregators) disclosed herein. Furthermore, any step or portion of a step of the method 700 can be performed by any suitable component of the communications system disclosed herein. Similarly, any combination of components of the communications system disclosed herein can perform any step or portion of a step of the method 700. However, for ease of description, the method 700 is described as being performed by a router, such as any of the routers disclosed herein including the edge router 110, the aggregation hub 130, the edge router 210, the aggregator 230, the edge router 310, the aggregator 430, and the router 570 described herein with reference to FIGS. 1A-5.

In block 705, the router receives network traffic in parallel over a plurality of transport links. In some embodiments, the router receives the network traffic over a plurality of secure tunnels corresponding to the plurality of transport links. The plurality of tunnels can implement any suitable tunneling technology, such as VPN.

In block 710, the router reorders a plurality of packets of the network traffic into a correct order to establish a flow of network traffic. In some embodiments, the router can be configured to buffer the received packets to enable reordering of the packets. The router can also be configured to control the size of the buffer based at least in part on the latency across the plurality of transport links.

In block 715, the router transmits spoofed acknowledgements to the origin router corresponding to received packets for connection-oriented protocols. For such connection-oriented protocols, the router is configured to establish a first network session with the origin router and a second network session with a destination network device. In accordance with the first network session and responsive to receiving the data packets, the router transmits ACKs back to the origin router without waiting for the corresponding ACKs from the destination network device.

In block 720, the router transmits the network traffic to the destination network device. The network device can include a user device, a remote server, a destination terminal, or the like. The network device can be associated with a private or public network to which the router is communicatively coupled. In some embodiments, the router provides network address translation to transmit the network traffic to the destination network device. Thus, the router is configured to aggregate the plurality of transport links into a single logical link for the network traffic, regardless of the transport layer protocol.

In accordance with the second network session established in block 715, the router forwards connection-oriented data packets to the destination network device and waits for corresponding ACKs from the destination network device. If no corresponding ACK is received, the router retransmits the data packets from its buffer.

### Additional Embodiments and Terminology

The present disclosure describes various features, no single one of which is solely responsible for the benefits described herein. It will be understood that various features described herein may be combined, modified, or omitted, as would be apparent to one of ordinary skill. Other combinations and sub-combinations than those specifically described herein will be apparent to one of ordinary skill, and are intended to form a part of this disclosure. Various methods are described herein in connection with various flowchart steps and/or phases. It will be understood that in many cases, certain steps and/or phases may be combined together such that multiple steps and/or phases shown in the flowcharts can be performed as a single step and/or phase. Also, certain steps and/or phases can be broken into additional sub-components to be performed separately. In some instances, the order of the steps and/or phases can be rearranged and certain steps and/or phases may be omitted entirely. Also, the methods described herein are to be understood to be open-ended, such that additional steps and/or phases to those shown and described herein can also be performed.

Some aspects of the systems and methods described herein can advantageously be implemented using, for example, computer software, hardware, firmware, or any combination of computer software, hardware, and firmware. Computer software can comprise computer executable code stored in a computer readable medium (e.g., non-transitory computer readable medium) that, when executed, performs the functions described herein. In some embodiments, computer-executable code is executed by one or more general purpose computer processors. A skilled artisan will appreciate, in light of this disclosure, that any feature or function that can be implemented using software to be executed on a general purpose computer can also be implemented using a different combination of hardware, software, or firmware. For example, such a module can be implemented completely in hardware using a combination of integrated circuits. Alternatively or additionally, such a feature or function can be implemented completely or partially using specialized computers designed to perform the particular functions described herein rather than by general purpose computers.

Multiple distributed computing devices can be substituted for any one computing device described herein. In such distributed embodiments, the functions of the one computing device are distributed (e.g., over a network) such that some functions are performed on each of the distributed computing devices.

Some embodiments may be described with reference to equations, algorithms, and/or flowchart illustrations. These methods may be implemented using computer program instructions executable on one or more computers. These methods may also be implemented as computer program products either separately, or as a component of an apparatus or system. In this regard, each equation, algorithm, block, or step of a flowchart, and combinations thereof, may be implemented by hardware, firmware, and/or software including one or more computer program instructions embodied in computer-readable program code logic. As will be appreciated, any such computer program instructions may be loaded onto one or more computers, including without limitation a general purpose computer or special purpose computer, or other programmable processing apparatus to produce a machine, such that the computer program instructions which execute on the computer(s) or other programmable processing device(s) implement the functions specified in the equations, algorithms, and/or flowcharts. It will also be understood that each equation, algorithm, and/or block in flowchart illustrations, and combinations thereof, may be implemented by special purpose hardware-based computer systems which perform the specified functions or steps, or combinations of special purpose hardware and computer-readable program code logic means.

Furthermore, computer program instructions, such as embodied in computer-readable program code logic, may also be stored in a computer readable memory (e.g., a non-transitory computer readable medium) that can direct one or more computers or other programmable processing devices to function in a particular manner, such that the instructions stored in the computer-readable memory implement the function(s) specified in the block(s) of the flowchart(s). The computer program instructions may also be loaded onto one or more computers or other programmable computing devices to cause a series of operational steps to be performed on the one or more computers or other programmable computing devices to produce a computer-implemented process such that the instructions which execute on the computer or other programmable processing apparatus provide steps for implementing the functions specified in the equation(s), algorithm(s), and/or block(s) of the flowchart(s).

Some or all of the methods and tasks described herein may be performed and fully automated by a computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other non-transitory computer-readable storage medium or device. The various functions disclosed herein may be embodied in such program instructions, although some or all of the disclosed functions may alternatively be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid state memory chips and/or magnetic disks, into a different state.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list. The word “exemplary” is used exclusively herein to mean “serving as an example, instance, or illustration.” Any implementation described herein as “exemplary” is not necessarily to be construed as preferred or advantageous over other implementations.

The disclosure is not intended to be limited to the implementations shown herein. Various modifications to the implementations described in this disclosure may be readily apparent to those skilled in the art, and the generic principles defined herein may be applied to other implementations without departing from the spirit or scope of this disclosure. The teachings of the invention provided herein can be applied to other methods and systems, and are not limited to the methods and systems described above, and elements and acts of the various embodiments described above can be combined to provide further embodiments. Accordingly, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

What is claimed is:

1. A method for multipath aggregation in a communications system that includes a plurality of transport links between an edge router and an aggregation hub, the method comprising:
receiving, from a network device, network traffic at the edge router destined for a destination network device;
establishing, using a performance enhancing proxy (PEP) module of the edge router, a first network session between the network device and the edge router for connection-oriented network traffic;
establishing, using the PEP module of the edge router, a second network session for connection-oriented network traffic between the edge router and a PEP module of the aggregation hub;
establishing, using a multipath VPN module of the edge router, a secure tunnel for each of the plurality of transport links;
responsive to receiving the network traffic at the PEP module of the edge router, sending a spoofed acknowledgement from the PEP module of the edge router to the network device and transmitting the network traffic to the PEP module of the aggregation hub using the corresponding plurality of secure tunnels, the spoofed acknowledgement adapted to spoof an acknowledgement from the destination network device; and
adjusting one or more parameters associated with the second network session to enable parallel transmission of connection-oriented network traffic over the plurality of transport links.

2. The method of claim 1, wherein adjusting the one or more parameters includes disabling a resend time window associated with a corresponding connection-oriented protocol.

3. The method of claim 2 further comprising:
receiving a set of acknowledgements corresponding to transmitted connection-oriented network traffic;
identifying missing acknowledgements in the set of acknowledgements; and
responsive to identifying a missing acknowledgement, retransmitting network traffic corresponding to the missing acknowledgement.

4. The method of claim 1, wherein adjusting the one or more parameters comprises:
storing an expected round-trip time for each of the plurality of transport links;
tracking an actual round-trip time for each of the plurality of transport links; and
responsive to determining that the actual round-trip time exceeds the expected round-trip time for a particular transport link, adjusting a resend time window in accordance with the actual round-trip time.

5. The method of claim 1, wherein adjusting the one or more parameters comprises transmitting compressed packets corresponding to the received network traffic.

6. The method of claim 1 further comprising:
receiving the transmitted network traffic at the aggregation hub;
reordering packets of the transmitted network traffic to match a packet order of the network traffic prior to being transmitted over the plurality of transport links;
transmitting spoofed acknowledgements corresponding to the transmitted network traffic; and
directing the transmitted traffic to the destination network device.

7. The method of claim 1, wherein the connection-oriented network traffic includes transport control protocol (TCP) traffic.

8. The method of claim 1, wherein the network traffic comprises connectionless network traffic that includes user datagram protocol (UDP) traffic.

9. The method of claim 1 further comprising determining a transport link of the plurality of transport links for each packet of the received network traffic based at least in part on a weighted algorithm comprising weights associated with a congestion level of the associated transport link.

10. The method of claim 9, wherein the weighted algorithm is a round-robin weighted algorithm.

11. An edge router in a communications system that includes a plurality of transport links between the edge router and an aggregation hub, the edge router comprising:
a performance enhancing proxy (PEP) module configured to establish network sessions for connection-oriented traffic;
a multipath virtual private network (MPVPN) module configured to establish secure tunnels over the plurality of transport links and to direct network traffic over the established secure tunnels;
a plurality of network interfaces configured to communicate with the plurality of transport links;
a data store storing computer executable instructions; and
a processor configured to control operation of the data store, the plurality of network interfaces, the PEP module, and the MPVPN module, the processor configured execute the computer executable instructions to:
receive network traffic at the edge router from a network device, the network traffic destined for a destination network device;
establish, using the PEP module, a first network session between the network device and the edge router for connection-oriented network traffic from the network device;
establish, using the PEP module, a second network session with a PEP module of the aggregation hub for connection-oriented network traffic between the edge router and the aggregation hub;
establish, using the MPVPN module, a secure tunnel for each of the plurality of transport links;
responsive to receiving the network traffic at the PEP module, send a spoofed acknowledgement from the PEP module to the network device and transmit the network traffic to the PEP module of the aggregation hub using the corresponding plurality of secure tunnels, the spoofed acknowledgement adapted to spoof an acknowledgement from the destination network device; and
adjust one or more parameters associated with the second network session to enable parallel transmission of connection-oriented network traffic over the plurality of transport links.

12. The edge router of claim 11, wherein the network traffic comprises connectionless network traffic that includes user datagram protocol (UDP) traffic.

13. The edge router of claim 11, wherein the connection-oriented network traffic comprises transport control protocol (TCP) traffic.

14. The edge router of claim 11, wherein adjusting the one or more parameters includes disabling a resend time window associated with a corresponding connection-oriented protocol.

15. The edge router of claim 14, wherein execution of the computer executable instructions further causes the processor to:
receive a set of acknowledgements corresponding to transmitted connection-oriented network traffic;
identify missing acknowledgements in the set of acknowledgements; and
responsive to identifying a missing acknowledgement, retransmit network traffic corresponding to the missing acknowledgement.

16. The edge router of claim 11, wherein adjusting the one or more parameters comprises:
store an expected round-trip time for each of the plurality of transport links;
track an actual round-trip time for each of the plurality of transport links; and
responsive to determining that the actual round-trip time exceeds the expected round-trip time for a particular transport link, adjust a resend time window in accordance with the actual round-trip time.

17. The edge router of claim 11, wherein adjusting the one or more parameters comprises transmitting compressed packets corresponding to the received network traffic.

18. The edge router of claim 11, wherein execution of the computer executable instructions further causes the processor to assign packets of the network traffic to individual transport links to transmit the network traffic in parallel over the plurality of transport links.

19. The edge router of claim 11, wherein execution of the computer executable instructions further causes the processor to determine a transport link of the plurality of transport links for each packet of the received network traffic based at least in part on a weighted algorithm comprising weights associated with a congestion level of the associated transport link.

20. The edge router of claim 19, wherein the weighted algorithm is a round-robin weighted algorithm.

21. An aggregation hub in a communications system that includes a plurality of transport links between an edge router and the aggregation hub, the aggregation hub comprising:
a performance enhancing proxy (PEP) module configured to establish a first network session between the aggregation hub and a destination network device and a second network session between the aggregation hub and the edge router;
a multipath virtual private network (MPVPN) module configured to receive network traffic from the edge router over a plurality of secure tunnels over the plurality of transport links;
a plurality of network interfaces configured to communicate with the plurality of transport links;
a data store storing computer executable instructions; and
a processor configured to control operation of the data store, the plurality of network interfaces, the PEP module, and the MPVPN module, the processor configured execute the computer executable instructions to:
receive the network traffic from the edge router in parallel over the plurality of transport links, the network traffic comprising a plurality of packets;
reorder packets of the received network traffic to match a packet order of the network traffic as transmitted from the edge router;
transmit to a PEP module of the edge router spoofed acknowledgements for connection-oriented packets of the received network traffic in accordance with the second network session, the spoofed acknowledgements adapted to spoof an acknowledgement from the destination network device; and
direct the received network traffic to the destination network device, the network traffic comprising connection-oriented network traffic and connectionless network traffic.

22. The aggregation hub of claim 21, wherein the connection-oriented network traffic comprises transport control protocol (TCP) traffic.

23. The aggregation hub of claim 21, wherein the connectionless network traffic comprises user datagram protocol (UDP) traffic.

24. The aggregation hub of claim 21, wherein execution of the computer executable instructions further causes the processor to:
detect a missing acknowledgement from the destination device; and
retransmit network traffic corresponding to the missing acknowledgement.

25. The aggregation hub of claim 21, wherein execution of the computer executable instructions further causes the processor to buffer the received network traffic using the MPVPN module prior to reordering the packets.

26. The aggregation hub of claim 25, wherein a size of a buffer is adjusted by the MPVPN module based on a latency difference between the plurality of transport links and a throughput of the plurality of transport links.
